(19) United States
(12) Patent Application Publication
(10) Pub. No.: US 2024/0269594 A1
(43) Pub. Date: Aug. 15, 2024

(54) FILTER STRUCTURE

(71) Applicant: TOYO ALUMINIUM EKCO PRODUCTS CO., LTD., Osaka (JP)

(72) Inventors: Hirofumi YAMASAKI, Osaka (JP); Masashi ADACHI, Osaka (JP)

(21) Appl. No.: 18/570,176

(22) PCT Filed: Jul. 7, 2022
(86) PCT No.: PCT/JP2022/026894

§ 371 Date: Dec. 14, 2023

(30) Foreign Application Priority Data
Jul. 8, 2021 (JP) 2021-113234

(51) Int. Cl. B01D 46/10; B01D 39/14

(52) U.S. Cl. CPC B01D 46/10; B01D 39/14; B01D 2201/308

(57) ABSTRACT

A filter structure includes: a filter layer that has air permeability to filter passing gas; an adhesive layer formed of an adhesive on at least a part of one side of the filter layer; and a peelable sheet layer laminated on a surface of the adhesive layer, in which a to-be-cut region is set on the filter layer, and a boundary portion indicating a boundary position between the to-be-cut region and a non-cut region of the filter layer is formed on at least one of the sheet layer and the filter layer. The to-be-cut region is cut off at a position indicated by the boundary portion before mounting on a target object, and therefore, the filter structure can be mounted on the target object while avoiding a portion that does not need to be attached to the target object, or a portion that causes a problem when attached.

### TECHNICAL FIELD

The present invention relates to a filter structure that is affixed to a target object such as an air conditioner (hereinafter, referred to as an AC), an air purifier, a range hood, or a vent to filter a gas passing through the filter structure.

### BACKGROUND ART

FIG. 10 is a rear view illustrating a known filter structure described in WO 2018/043522 A. FIG. 11 illustrates a known air purifier described in JP-A-2017-32227. FIG. 11(A) is a perspective view illustrating a state during operation, and FIG. 11(B) is a perspective view of a state in which a front decorative laminate has been removed.

A known filter structure G illustrated in FIG. 10 includes a sheet-like filter layer 100, an adhesive layer 101 formed of an adhesive on one side of the filter layer 100, and a sheet layer (not illustrated) such as a release sheet laminated on the surface of the adhesive layer 101.

An air permeable material such as nonwoven fabric is used as the filter layer 100. Note that, in this example, the filter layer 100 is formed in a rectangular form of which long side direction runs vertically and short side direction runs horizontally.

The adhesive layer 101 includes an outline adhesive layer 102 formed along the outer peripheral edge portion of the filter layer 100, a plurality of reinforcing adhesive layers 103 that are formed inward of the outline adhesive layer 102 both in the vertical direction and in the horizontal direction and form a lattice shape, and heart-shaped design adhesive layers 104 formed in regions surrounded by the lines of the lattice formed by the vertical and horizontal reinforcing adhesive layers 103.

When the filter structure G is attached to an intake of an air purifier and used, a portion of the filter layer 100 through which air passes becomes dirty and black and colored due to accumulation of, for example, dust collected, whereas, for example, dust is less likely to accumulate on a portion where the adhesive layer 101 is formed since ventilation of air is suppressed. Hence, under continued use, the form of the adhesive layer 101 visually stands up white, and in particular, the design adhesive layers 104 of the heart shape are visually recognized, so that the function of indicating the replacement time of the filter structure G is exhibited.

Note that, in addition to a back-to-front airflow system in which an intake is provided on the back side, air purifiers also include models with a front-to-back airflow system as in an air purifier K illustrated in FIG. 11. In the illustrated air purifier K of the front-to-back airflow system, an intake 122 in which a sheet-like air purifying means 123 is placed is provided on the front side of a main body 120, and the intake 122 is covered with a front decorative laminate 121. The upper part of the front decorative laminate 121 is rotatably supported by upper support portions 124, and the lower part of the front decorative laminate 121 is supported, by lower support portions 125 driven to be movable forward and backward, in such a manner as to be movable in a front-and-back direction.

The air purifier K is configured in such a manner that during use, the lower support portions 125 are driven forward, and the lower part of the front decorative laminate 121 is rotated forward on the upper support portions 124 as axes, and consequently, the main body portion 120 is separated from the front decorative laminate 121 to cause the intake to communicate with outside air.

### CITATION LIST

### Patent Literature

Patent Literature 1: WO 2018/043522 A
Patent Literature 2: JP-A-2017-32227

The known filter structure G illustrated in FIG. 10 is simply required to be attached to the intake of an air purifier of the back-to-front airflow system with the size unchanged, or by being cut along the vertical or horizontal reinforcing adhesive layer to the size of the intake.

However, the air purifier K of the front-to-back airflow system such as illustrated in FIG. 11 is provided, around the intake 122, with the upper support portions 124 and the lower support portions 125, which support the front decorative laminate 121 in four places in the up-and-down direction, and therefore, the upper support portions 124 and the lower support portions 125 interfere with the filter structure G. Hence, if the filter structure G is mounted on the intake 122 of the air purifier K of the front-to-back airflow system, the portions that interfere with the upper support portions 124 and the lower support portions 125, that is, regions 110 including four corners (regions surrounded by dot-and-dash lines in FIG. 10) need to be cut off.

However, in the known filter structure G, the areas to be cut off are not clearly shown. Therefore, larger areas than are necessary may be cut off and, as a result, the filter structure G may not be able to completely cover the intake, or conversely, sufficient areas may not be able to be cut off and, as a result, portions that interfere with the support portions of the air purifier may be created. Consequently, places that fail in adhesion may be created around the intake.

Moreover, a ceiling-embedded commercial AC may be provided, around an intake placed on a ceiling surface, with a sensor for detecting a room temperature or a human body. When the filter structure is attached as it is to such an AC, a part of the filter structure may conceal the sensor and impair the function of the sensor. Therefore, it is necessary to cut off a portion of the filter layer that may interfere with the sensor. However, in the known filter structure, the area of the filter layer to be cut off corresponding to the sensor is not clearly shown, which may lead to a problem that a larger area than is necessary is cut off, and as a result, the filter layer cannot cover the intake completely, or conversely, a portion that interferes with the sensor remains, which inhibits the function of the sensor.

An object of the present invention is to provide a filter structure that, in a case where a mounting target object includes a portion to which a filter layer does not need to be attached, or a portion that causes a problem in a case where the filter layer is attached, can be attached while avoiding these portions.

### DISCLOSURE OF INVENTION

In order to achieve the above object, a filter structure according to a first aspect of the invention includes: a filter layer that has air permeability to filter passing gas; an adhesive layer formed of an adhesive on at least a part of one side of the filter layer; and a peelable sheet layer laminated on a surface of the adhesive layer, in which a to-be-cut region is set on the filter layer, and a boundary portion indicating a boundary position between the to-be-cut region and a non-cut region of the filter layer is formed on at least one of the sheet layer and the filter layer.

With this configuration, it is possible to obtain operation 1 in which the boundary portion of at least one of the sheet layer and the filter layer indicates a position in which the filter structure is cut.

The filter structure according to a second aspect of the invention has the configuration of the invention according to the first aspect, in which the boundary portion includes at least one selected from: a visual indication, such as a line, a graphic, a character, a symbol, or a certain colored area, formed by printing; a mark formed by embossing or ruled line processing; and a cutting assist portion such as perforations or a half cut.

With this configuration, the boundary portion includes at least one of the visual indication, the mark, or the cutting assist portion, and therefore, it is possible to obtain operation 2 in which the position of the boundary portion can be recognized.

The filter structure according to a third aspect of the invention has the configuration of the invention according to the first or second aspect, in which the filter layer has a rectangular form, and the to-be-cut region is set in at least one corner portion of the filter layer.

With this configuration, it is possible to obtain operation 3 in which at least one of four corners of the rectangular filter layer is the to-be-cut region.

As described above, the filter structure according to the first aspect of the invention can obtain operation 1 and therefore exerts the following effects: When the filter structure is mounted on a target object, the to-be-cut region is cut off at the position indicated by the boundary portion, and therefore, it is possible to mount the filter structure on the target object while avoiding a portion that does not need to be attached to the target object, or a portion that causes a problem when attached. The limits of the to-be-cut region can be checked by use of the boundary portion, and therefore, it is possible to easily cut off an appropriate area of the filter layer on the basis of the boundary portion. Moreover, it is also possible to use the filter structure by cutting off the to-be-cut region and to use the filter structure without cutting off the to-be-cut region. Therefore, one type of filter structure is adaptable for a plurality of types of target objects. Furthermore, in a case where the boundary portion is formed on the sheet layer, a similar effect can be exerted without forming the boundary portion on the filter layer. The boundary portion formed on the sheet layer has a high degree of freedom in form such as coloring or presenting explanatory text or a symbol. Note that since the sheet layer is removed from the filter structure at the time of use, even if such a boundary portion is formed, the design of the filter layer is not affected.

The filter structure according to the second aspect of the invention can obtain operation 2 in addition to the effect of the invention according to the first aspect, and therefore, in a case where the visual indication such as print or a mark is adopted, it is easy to visually recognize the limits of the to-be-cut region. In a case where the cutting assist portion such as perforations is adopted, it is easy to cut off the to-be-cut region.

The filter structure according to the third aspect of the invention can obtain operation 3 in addition to the effects of the invention according to the first or second aspect. Therefore, even if the filter structure includes a portion that does not need to be attached to the target object, or a portion that causes a problem when attached, at least one part of the to-be-cut region is cut off to enable appropriately mounting the filter structure while avoiding these portions.

### BRIEF DESCRIPTION OF DRAWINGS

FIG. 1A is a perspective view illustrating a filter structure according to a first embodiment of the present invention in a state in which a sheet layer is separated.

FIG. 1B is a front view of the filter structure illustrated in FIG. 1A.

FIG. 2 is a front view of a filter structure according to a second embodiment of the present invention.

FIG. 3A is a perspective view illustrating a state in which a sheet layer is separated, for explaining a filter structure according to a third embodiment of the present invention.

FIG. 3B is a rear view of the filter structure illustrated in FIG. 3A.

FIG. 4 is a rear view of a filter structure according to a fourth embodiment of the present invention.

FIG. 5 is a rear view of a filter structure according to a fifth embodiment of the present invention.

FIG. 6 is a rear view of a filter structure according to a sixth embodiment of the present invention.

FIG. 7 is a rear view illustrating cutting examples of the filter structure illustrated in FIG. 6.

FIG. 8 is a rear view illustrating different cutting examples of the filter structure illustrated in FIG. 6.

FIG. 9 is a rear view illustrating a part of a filter structure according to a seventh embodiment of the present invention.

FIG. 10 is a rear view illustrating a known filter structure described in Patent Literature 1.

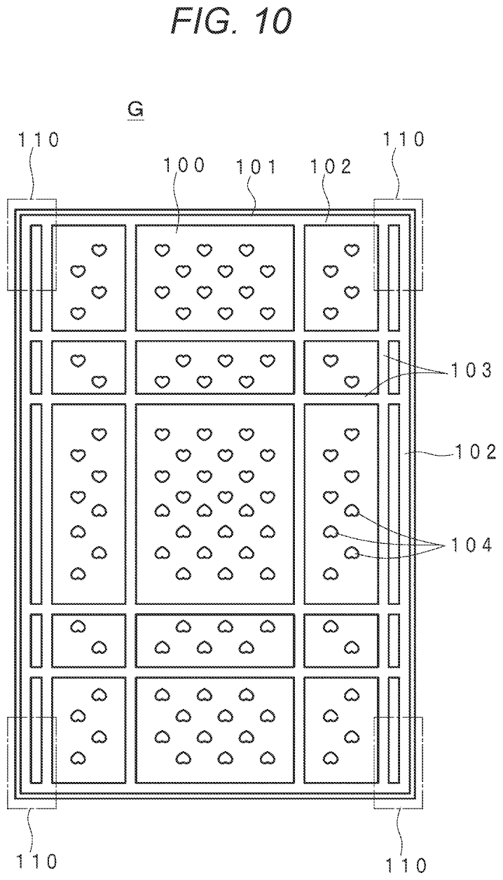

FIG. 11 illustrates a known air purifier described in Patent Literature 2, FIG. 11(A) is a perspective view illustrating a state during operation, and FIG. 11(B) is a perspective view of a state in which a front decorative laminate has been removed.

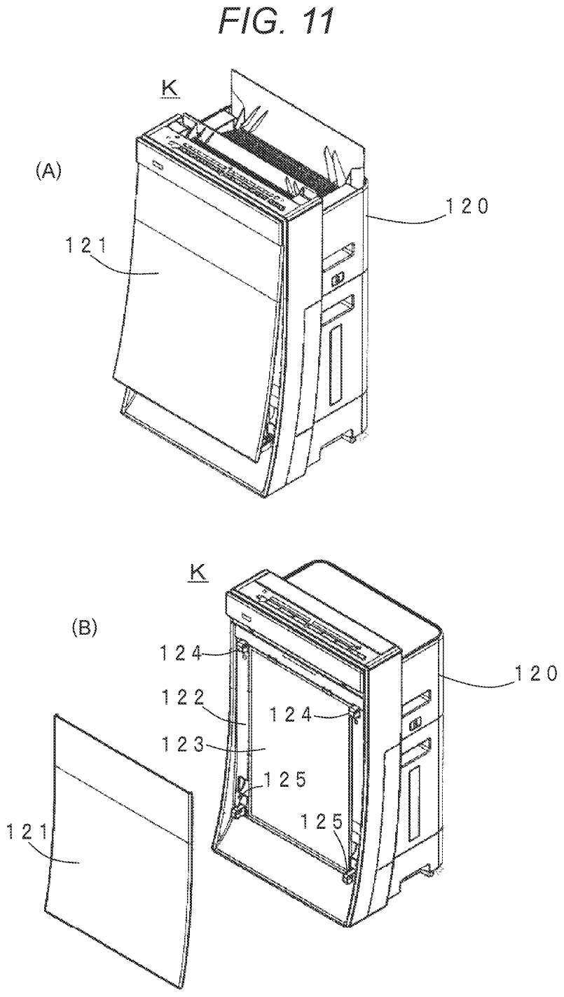

### DESCRIPTION OF EMBODIMENTS

### First Embodiment

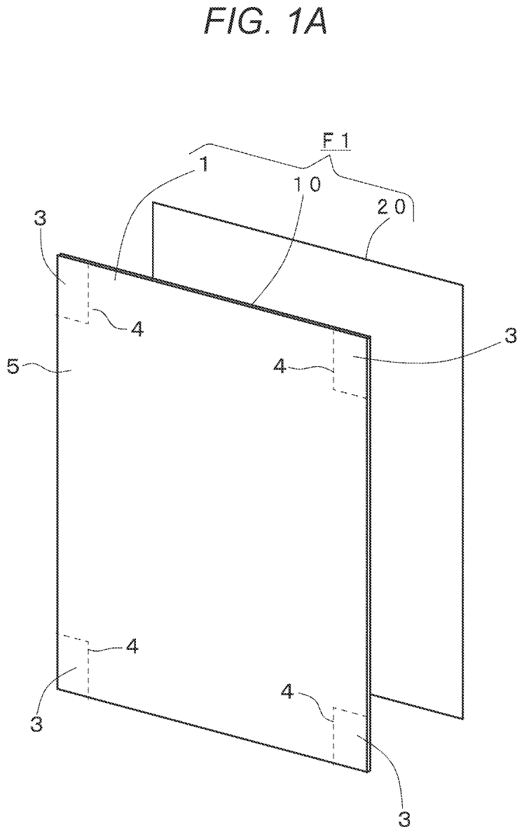

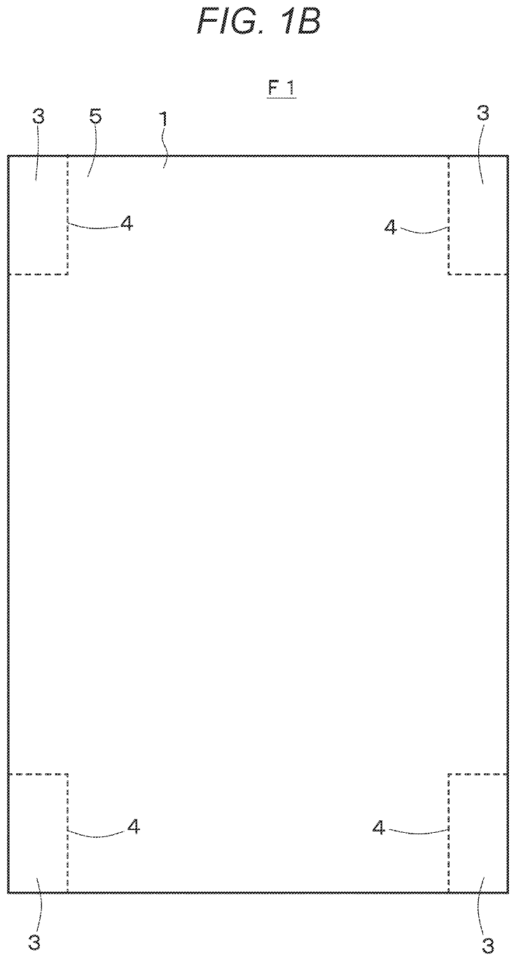

FIG. 1A is a perspective view illustrating a filter structure according to a first embodiment of the present invention in a normal installed state in which a sheet layer is separated, and FIG. 1B is a front view of the filter structure illustrated in FIG. 1A. Note that in the following description, a side of the filter structure on which the sheet layer is laminated on a filter layer is assumed to be the back side, and the opposite side is assumed to be the front side.

With reference to these drawings, a filter structure F1 includes a sheet-like filter layer 1 that has air permeability to filter passing gas, an adhesive layer 10 formed of an adhesive on at least a part of one side of the filter layer 1, and a peelable sheet layer 20 laminated on a surface of the adhesive layer 10.

The filter layer 1 is made of, for example, nonwoven fabric, woven fabric, or knitted fabric, and has practical strength while achieving compatibility between collection of, for example, dust and ventilation of the gas. Preferably, nonwoven fabric including synthetic resin fiber, for example, polyester such as polyethylene terephthalate (PET), a copolymer based on polypropylene or propylene, and an acrylic including modacrylic can be used, but is not limited to them. A method for manufacturing the nonwoven fabric is not limited, either. For example, nonwoven fabric manufactured by a known manufacturing process such as chemical bonding or thermal bonding can be suitably used. Moreover, the filter layer 1 may undergo treatment to exhibit, for example, flame retardant, antiviral, antimicrobial, and antifungal functions.

The adhesive forming the adhesive layer 10 is not particularly limited, and, for example, a two-component adhesive including a base resin and a curing agent such as a two-component polyurethane-based adhesive, or a hot-melt adhesive such as an acrylic hot melt adhesive can be used. Moreover, additives such as a tackifier to increase adhesion, an ultraviolet absorbent, a filler, a colorant, an antioxidant, an antifoaming agent, and a light stabilizer, and various additives for suppressing, for example, a decrease in adhesive strength at low temperatures, and adhesive residues may be blended into the adhesive as necessary. A known method can be adopted as a method for forming the adhesive layer on the filter layer. For example, a method can be adopted in which the adhesive is applied directly to the filter layer, or the adhesive is indirectly applied by, for example, a method in which the adhesive is temporarily applied to, for example, a peelable sheet layer described below and then the sheet layer is brought into contact with the filter layer to transfer the adhesive to the filter layer, and a coating is formed and then dried (hardened). The application method for applying the adhesive layer directly or indirectly to the filter layer is not limited, but can be performed by, for example, a roller, a spray, a brush, or printing. In other words, any of, for example, roll coating, comma coating, die coating, inkjet printing, reverse coating, silk screening, or gravure coating, which uses a known apparatus, can be adopted. In a case of direct application, for example, the adhesive layer can be formed on the filter layer by spraying the adhesive all over or partially on one side of the filter layer. Moreover, in a case of indirect application, for example, a method can be adopted in which the adhesive is printed by a roll or the like on, for example, a peelable sheet layer coated with silicone, and then the side of the sheet layer on which the adhesive layer is provided is brought into contact with the filter layer and pressure-bonded by a roll or the like to the filter layer to transfer the adhesive layer to the filter layer.

For example, a PET film having at least one side coated with silicone is used as the sheet layer 20. Since the surface of the adhesive layer is protected by providing the sheet layer, it is possible to prevent the adhesive layer from being attached to an object other than the intended target object before the filter structure is used. Moreover, handleability increases, for example, a plurality of filter structures can be placed on top of another. At the time of use, it is simply required to peel off the sheet layer and attach the exposed adhesive layer to the target object like a sticker. In addition to the PET film, for example, cellophane, a resin film other than PET, paper subjected to surface treatment such as resin coating, and a metal sheet can also be used as the material of the sheet layer 20.

A mounting target of the filter structure F1 of the example illustrated in FIGS. 1A and 1B is assumed to be an air purifier of the front-to-back airflow system. The filter layer 1 has a rectangular shape. When the filter layer 1 is mounted as it is on the air purifier of the front-to-back airflow system, four corners of the filter layer 1 interfere with support members provided around an intake to support a front decorative laminate. Hence, in the example, a to-be-cut region 3 that is a part of the filter layer 1 to be cut off is set in each of the four corners, and boundary portions 4 indicating boundary positions between the to-be-cut regions 3 and a non-cut region 5 are formed on the filter layer 1. The boundary portions 4 are indicated with, for example, print, perforations, or half cuts on the surface of, for example, the filter layer 1, so that the outlines of the to-be-cut regions 3 can be visually recognized. A method for forming the boundary portions 4 is not particularly limited, and the boundary portions 4 may be visual indications such as lines, graphics, characters, symbols, or certain colored areas, which are formed by printing, marks formed by embossing or ruled line processing, or cutting assist portions such as perforations or half cuts.

According to the filter structure F1 of the example configured as described above, the to-be-cut regions 3 are cut off at the positions of the boundary portions 4 as needed before the filter structure F1 is mounted on the air purifier of the front-to-back airflow system that is the mounting target object. Next, the sheet layer 20 is peeled off, and the exposed adhesive layer 10 is positioned and attached to the intake like a sticker. Consequently, it is possible to mount the filter structure F1 while avoiding interference between the support members of the front decorative laminate protruding around the intake and the filter layer 1.

Note that the adhesive layer 10 may be formed by spraying as described above, may be formed in a band shape or a lattice shape by pattern printing, or may form a pictorial pattern being a designed character in addition to a character, a symbol, or a graphic. Moreover, the boundary portions may be formed by the adhesive layer 10.

### Second Embodiment

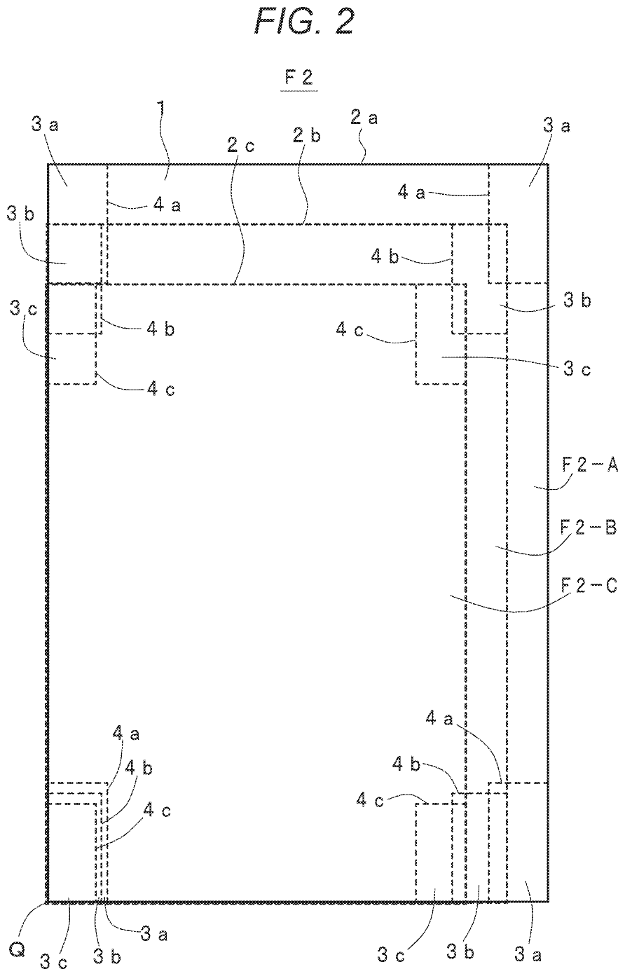

FIG. 2 is a front view of a filter structure according to a second embodiment of the present invention.

The main features of the configuration of a filter structure F2 of the example are common to those of the first embodiment, and differences are mainly described here.

The filter structure F2 of the example can be adapted to air purifiers having different sized intakes, which are mounting targets. In other words, the filter structure F2 of the example includes, in addition to a filter structure F2-A having a size corresponding to an outline 2a of the entire filter layer 1, a filter structure F2-B having an outline 2b smaller than the outline 2a, and a filter structure F2-C having an outline 2c still smaller than the outline 2b, and is configured in such a manner that one of the three different sized filter structures can be selected according to the conditions. Here, the filter structures F2-A to F2-C have similar shapes.

In the example, the placement of the outlines 2b and 2c is set in such a manner as to have a form in which a specific corner portion of each of the outlines 2b and 2c meets one vertex Q of the outline 2a of the entire filter layer 1. Furthermore, boundary portions 4a, 4b, and 4c indicating the limits of to-be-cut regions 3a, 3b, and 3c are formed by, for example, printing, perforations, or half cutting in four corners of each of the outlines 2a, 2b, and 2c on the surface of the filter layer 1. Note that a method for forming the boundary portions 4a, 4b, and 4c is not particularly limited, and the boundary portions 4a, 4b, and 4c may be visual indications such as lines, graphics, characters, symbols, or certain colored areas, which are formed by printing, marks formed by embossing or ruled line processing, or cutting assist portions such as perforations or half cuts, as in the first embodiment. Moreover, a method similar to the method for forming the boundary portions 4a, 4b, and 4c can be adopted as a method for forming the outline 2b of the filter structure F2-B and the outline 2c of the filter structure F2-C.

With such a configuration, when the size of the filter layer of the filter structure F2 of the example needs to be reduced to the size of the intake, the filter layer 1 is cut along the outline 2b (or 2c) selected according to the size of the intake, and therefore, it is possible to have the filter structure F2-B (or F2-C) of the optimum size. Then, the to-be-cut regions 3b (or 3c) of the filter layer 1 of the filter structure F2-B (or F2-C) obtained by cutting are cut off along the boundary portions 4b (or 4c) as needed, and therefore, the filter structure F2-B (or F2-C) can be attached to the intake while avoiding interference between the protrusions around the intake and the filter layer 1.

In terms of the filter structure of the example, when the filter layer is cut to the size of the intake, it is simply required to cut the filter layer straight in two directions along two specific adjacent sides, so that a filter structure having a target size can be obtained with a small number of times of cutting. Moreover, in the example, since the to-be-cut regions are indicated by the boundary portions on the filter structure after cutting, the limits of the to-be-cut regions can be easily visually recognized, and the cutting operation is easy.

Note that the adhesive layer 10 may form the outline 2b of the filter structure F2-B and the outline 2c of the filter structure F2-C.

### Third Embodiment

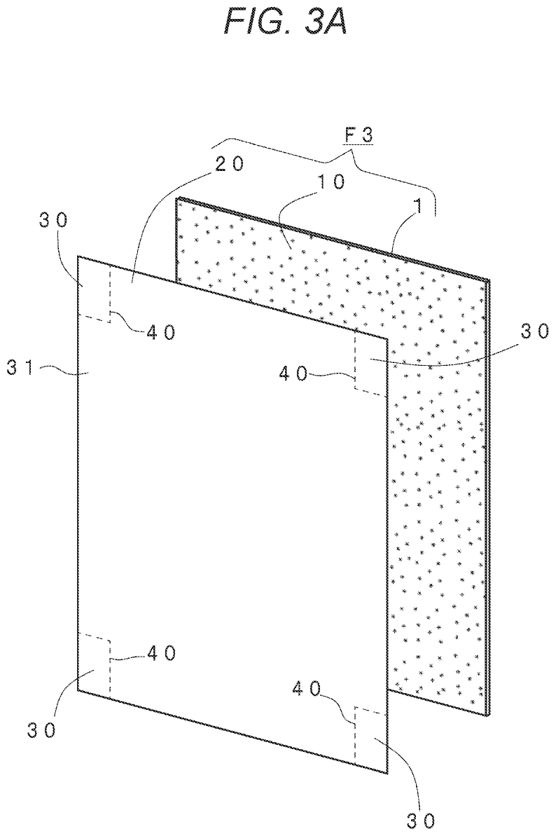

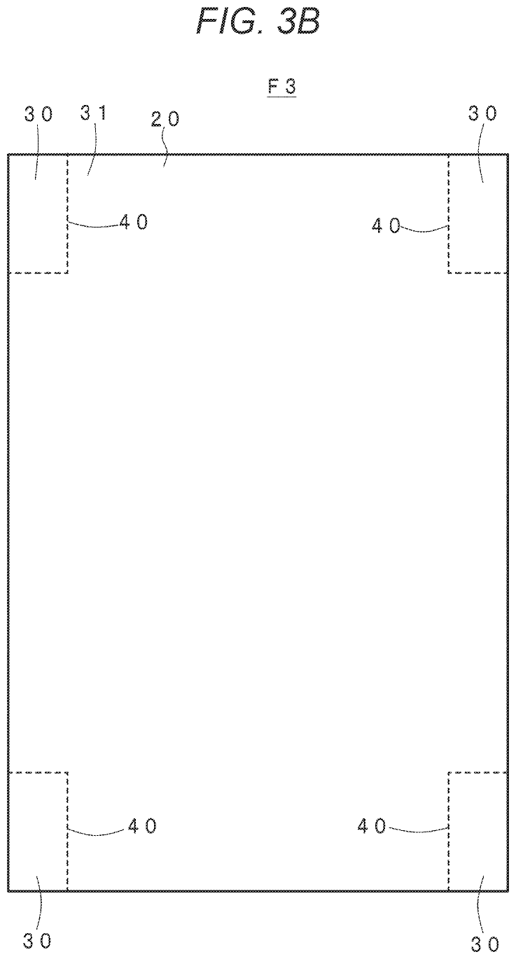

FIG. 3A is a perspective view illustrating a state in which a sheet layer is separated, for explaining a filter structure according to a third embodiment of the present invention, and FIG. 3B is a rear view of the filter structure illustrated in FIG. 3A. In other words, FIGS. 3A and 3B illustrate the sheet layer.

The main features of the configuration of a filter structure F3 of the example are common to those of the first embodiment, and differences are mainly described here.

With reference to these drawings, a mounting target of the filter structure F3 of the example is assumed to be an air purifier of the front-to-back airflow system, and a to-be-cut region for cutting off a part of the filter layer 1 is set in each of four corners of the filter layer 1. This example is different from the first embodiment in that boundary portions 40 indicating boundary positions between to-be-cut regions 30 and a non-cut region 31 are formed on the sheet layer 20 and that boundary portions indicating boundary positions between to-be-cut regions and a non-cut region are not formed on the filter layer 1.

The boundary portions 40 are formed on, for example, the surface of the sheet layer 20 by, for example, printing, perforations, or half cutting, and visually indicate the outlines of the to-be-cut regions 30.

According to the filter structure F3 of the example configured as described above, the to-be-cut regions 30 are cut off at the positions of the boundary portions 40 as needed before the filter structure F3 is mounted on the air purifier of the front-to-back airflow system that is the mounting target object. Next, the sheet layer 20 is peeled off, and the exposed adhesive layer 10 is positioned and attached to the intake like a sticker. Consequently, it is possible to mount the filter structure F3 while avoiding interference with the support members of the front decorative laminate protruding around the intake.

In the example, the boundary portions 40 are formed on the sheet layer 20, and therefore, it is not necessary to form boundary portions indicating boundary positions between to-be-cut regions and a non-cut region on the filter layer 1. The boundary portions 40 formed on the sheet layer 20 have a high degree of freedom in form such as coloring or presenting explanatory text or symbols, and can ensure that the limits of the to-be-cut regions 30 are recognized. Note that the sheet layer 20 is removed from the filter structure F3 at the time of use; therefore, even if such boundary portions are formed, it does not affect the design of the filter layer 1.

Since the boundary portions 40 are formed on the sheet layer 20, the design and formation method of the adhesive layer 10 are not limited, so that the degree of freedom in the form and formation method of the adhesive layer 10 can be increased. Therefore, in addition to forming the adhesive layer 10 by spraying as in the example, the adhesive layer 10 may be formed in a band shape or a lattice shape by pattern printing, or may form a pictorial pattern being a designed character in addition to a character, a symbol, or a graphic.

### Fourth Embodiment

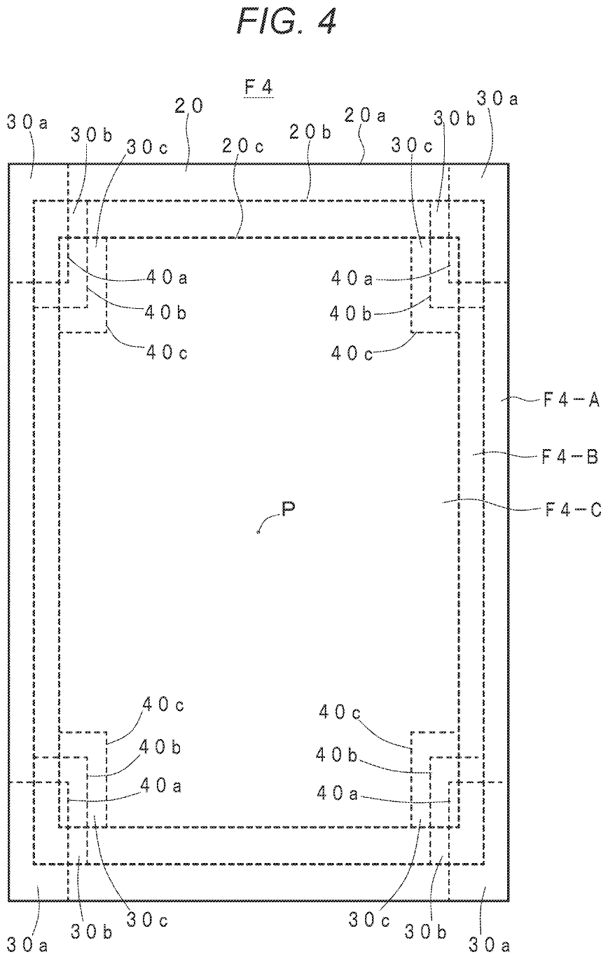

FIG. 4 is a rear view of a filter structure according to a fourth embodiment of the present invention.

The main features of the configuration of a filter structure F4 of the example are common to those of the third embodiment, and differences are mainly described here.

The filter structure F4 of the example can be adapted to air purifiers having different sized intakes, which are mounting targets. In other words, the filter structure F4 of the example includes, in addition to a filter structure F4-A having a size corresponding to an outline 20a of the entire sheet layer 20, a filter structure F4-B having an outline 20b smaller than the outline 20a, and a filter structure F4-C having an outline 20c still smaller than the outline 20b, and is configured in such a manner that one of the three different sized filter structures can be selected according to the conditions. Here, the filter structures F4-A to F4-C have similar shapes.

The outline 20b of the filter structure F4-B and the outline 20c of the filter structure F4-C can be formed by a method similar to the method for forming the boundary portions of the third embodiment. Moreover, the outlines 20a to 20c of the example are formed in such a manner that the centers of the outlines 20b and 20c coincide with a center P of the outline 20a of the entire sheet layer 20 and are placed substantially concentrically. Furthermore, boundary portions 40a, 40b, and 40c indicating the limits of to-be-cut regions 30a, 30b, and 30c are formed in four corners of each of the outlines 20a, 20b, and 20c, and can be formed by a method similar to the method for forming the boundary portions of the third embodiment.

With such a configuration, when the size of the filter layer of the filter structure F4 of the example needs to be reduced to the size of the intake, the filter layer is cut along the outline 20b (or 20c) selected according to the size of the intake, and therefore, it is possible to have the filter structure F4-B (or F4-C) of the optimum size. Then, the to-be-cut regions 30b (or 30c) of the filter layer of the filter structure obtained by cutting are cut off along the boundary portions 40b (or 40c) as needed, and therefore, the filter structure F4-B (or F4-C) can be attached to the intake while avoiding interference between the protrusions around the intake and the filter layer.

### Fifth Embodiment

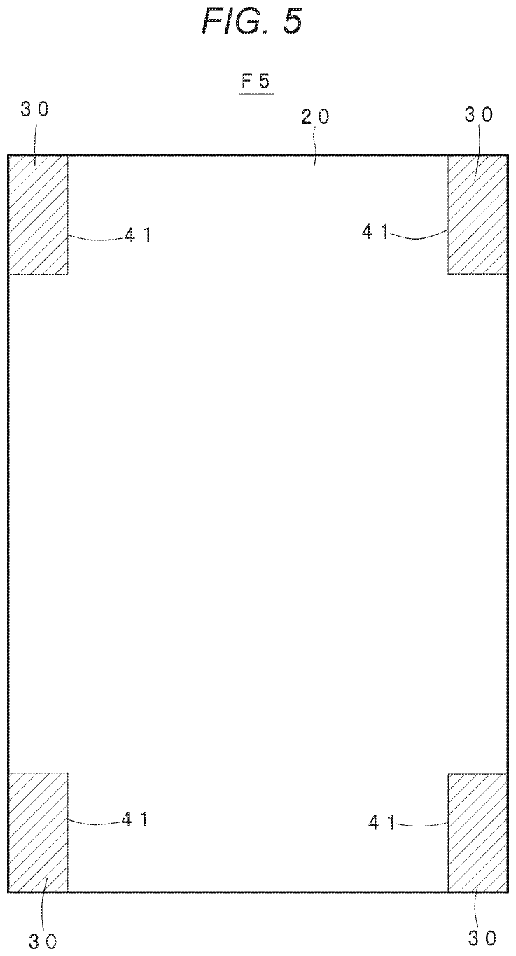

FIG. 5 is a rear view of a filter structure according to a fifth embodiment of the present invention.

The main features of the configuration of a filter structure F5 of the example are common to those of the third embodiment, and differences are mainly described here.

In the example, the limits of the to-be-cut regions 30 on the sheet layer 20 are shown as areas by, for example, coloring, shading, or hatching. Therefore, in the example, the outlines of the area indication portions indicating the to-be-cut regions 30 are boundary portions 41.

As described above, in the example, since the to-be-cut regions 30 are shown as areas, it is easy to visually recognize the limits of the to-be-cut regions 30.

### Sixth Embodiment

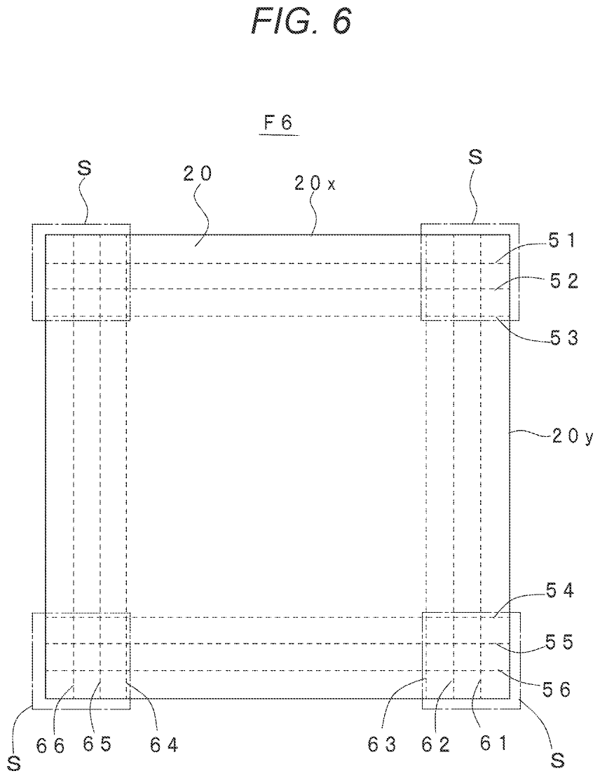

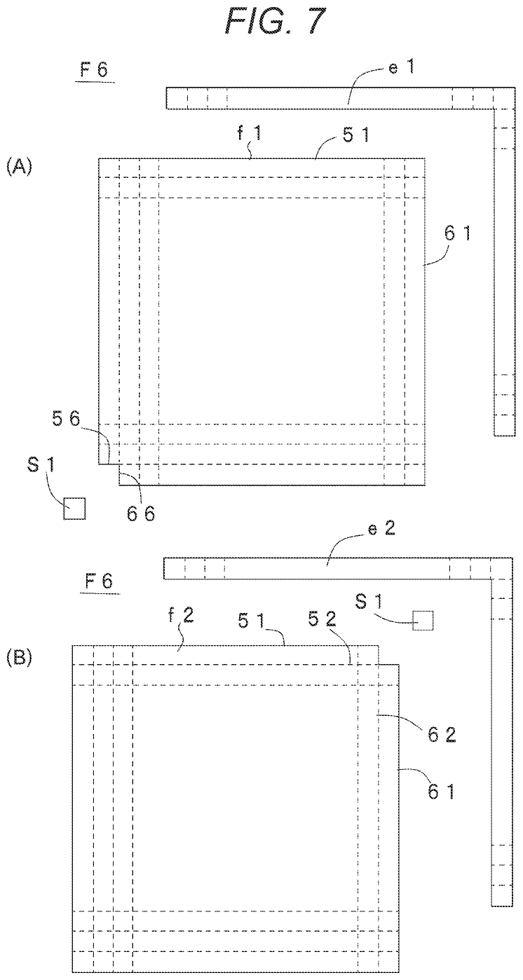

FIG. 6 is a rear view of a filter structure according to a sixth embodiment of the present invention, and FIG. 7 is a rear view illustrating cutting examples of the filter structure illustrated in FIG. 6.

The main features of the configuration of a filter structure F6 of the example are common to those of the third embodiment, and differences are mainly described here.

A target for use of the filter structure F6 of the example is assumed to be a ceiling-embedded commercial AC. Many ACs of this type are known which have a structure in which a panel facing the interior of a room has a substantially square outline, a substantially square intake is provided in the center of the panel, and an air outlet is placed outward of each of four sides of the intake. The filter structure F6 of the example is formed in a square shape in accordance with the shape of the intake of such an AC.

In terms of the filter structure F6 of the example, a plurality of cutting lines for cutting the filter layer 1 is formed on the sheet layer 20. Specifically, a plurality of cutting lines 51 to 56 parallel to an outline 20x (the horizontal direction) in one direction of the square sheet layer 20 and a plurality of cutting lines 61 to 66 parallel to an outline 20y (the vertical direction) in another direction perpendicular to the plurality of cutting lines 51 to 56 are formed on the sheet layer 20 by, for example, printing, perforations, or half cutting as in the method for forming the boundary portions of the third embodiment. Then, lattice-shaped regions that include four corners of the sheet layer 20 and in which the cutting lines 51 to 56 cross the cutting lines 61 to 66 are set as to-be-cut regions S.

The filter structure F6 of the example can be adapted to ACs having different sized intakes by forming the cutting lines in the above pattern on the sheet layer 20. With reference to FIGS. 7(A) and 7(B), the filter layer 1 is cut, for example, along one cutting line 51 in the horizontal direction and along one cutting line 61 in the vertical direction to cut off L-shaped portions e1 and e2. Consequently, filter structures f1 and f2 having a size smaller than the original filter structure F6 can be obtained, and therefore can be mated to a size smaller intake of an AC.

Moreover, the filter structure F6 of the example has the plurality of cutting lines in the horizontal direction and the vertical direction, and can be variously changed in size by cutting the filter structure F6 along cutting lines appropriately selected from the plurality of cutting lines. Therefore, the example provides a filter structure that can be mated to various sized intakes.

Note that, in the example, all the shapes of the filter layers after cutting are set in such a manner as to be substantially square similar to the shape of the original filter layer. With this configuration, the present invention can be easily applied to target objects of which shapes are basically square even if their dimensions are different, such as commercial ACs.

Incidentally, in terms of a ceiling-embedded commercial AC, a sensor for detecting a human body or a temperature may be placed around the intake, and the sensor may be concealed by the filter layer, depending on the position of the sensor, when the filter structure is attached to the ceiling-embedded commercial AC. Hence, in the example, the to-be-cut regions S are set to cut off a portion of the filter layer that may correspond to the sensor. Specifically, it is possible to set portions including the four corner portions of the substantially square filter layer 1 as the to-be-cut regions S, respectively, and select at least one of the to-be-cut regions S, and cut off a part of the selected to-be-cut region S in accordance with the size of a removal target object as needed. In other words, the criss-crossed cutting lines in the to-be-cut regions S function as boundary portions.

For example, in the example of FIG. 6, the plurality of cutting lines forms a lattice shape in each of the to-be-cut regions S, and the each of the to-be-cut regions S is divided into nine squares by the criss-crossed cutting lines. The example of FIG. 7(A) has an aspect that, in the filter structure f1 after cutting along the cutting lines 51 and 61, a one-square portion S1 defined by the cutting lines 56 and 66 in the to-be-cut region S is cut off. In this case, parts of the cutting lines 56 and 66 form a boundary portion.

Moreover, in the example of FIG. 7(B), on the filter structure f2 after cutting along the cutting lines 51 and 61, a region defined by the cutting lines 52 and 62 in a corner portion newly formed by the cutting lines 51 and 61 after cutting is set as the portion S1 to be newly cut off. In this case, parts of the cutting lines 52 and 62 form a boundary portion.

Note that the portion that is actually cut off in the to-be-cut region S can be changed as appropriate, and an aspect in which two or more squares are cut off, or an aspect in which all the nine squares are removed may be adopted. Furthermore, two or more portions may be cut off in the to-be-cut region S, and a plurality of to-be-cut regions S of the four to-be-cut regions S may be selected as cutoff targets.

Note that, in the example, the cutting lines form a lattice shape inside the each of the to-be-cut regions S, and therefore, it is easy to find the cutoff limits in accordance with the removal target object.

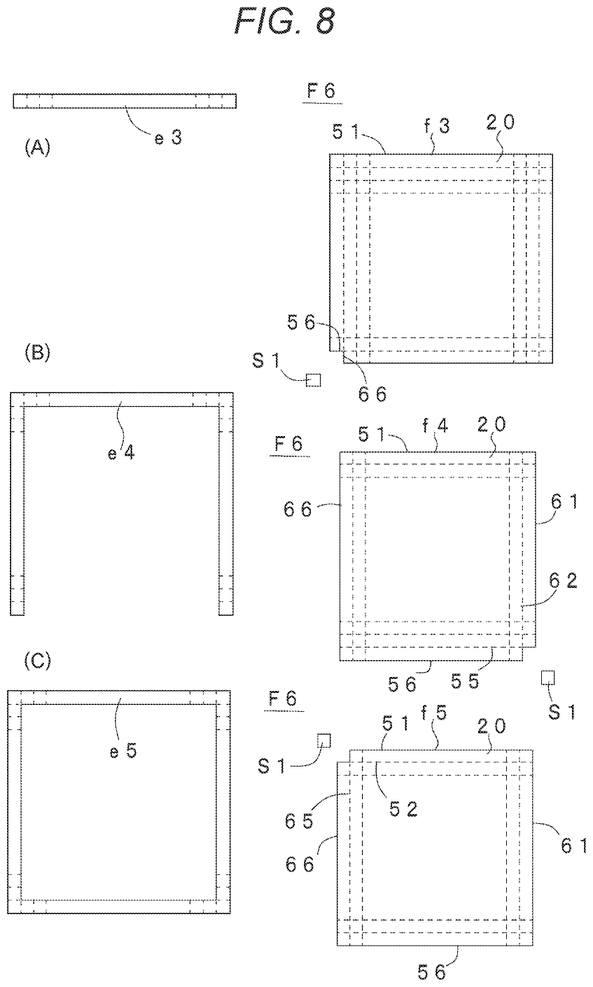

FIG. 8 is a rear view illustrating different cutting examples of the filter structure illustrated in FIG. 6.

In the cutting examples illustrated in FIG. 7 described above, the filter structure is cut in an L shape along the cutting lines along the outlines 20x and 20y on the two specific adjacent sides of the outline of the sheet layer 20. However, the present invention is not limited to this, and the filter structure may be cut straight along the cutting line only along one of the outlines, may be cut in a U shape along the cutting lines along the outlines on three sides, or may be cut along the cutting lines along all four sides of the outline to be cut out in a square shape.

Specifically, as illustrated in FIG. 8(A), the filter structure F6 may be cut along one cutting line 51 to separate a straight portion e3, and obtain a filter structure f3 having a shorter length in the vertical direction. Alternatively, as illustrated in FIG. 8(B), the filter structure F6 may be cut along three cutting lines 51, 61, and 66 along three sides of the outline to separate a U-shaped portion e4, and obtain a size smaller filter structure f4. Furthermore, as illustrated in FIG. 8(C), the filter structure F6 may be cut along four cutting lines 51, 56, 61, and 66 along all the four sides of the outline to separate a hollow square portion e5, and obtain a filter structure f5 being a square cutout.

Furthermore, in each of the embodiments illustrated in FIGS. 8A to 8C, the portion S1 of the filter structure may be cut off from the filter structures f3 to f5 formed after the cutting, using the cutting lines, to avoid interference with a removal target object such as a sensor.

Moreover, in the example of FIG. 8(A), the filter structure F6 may be cut straight also on any one of the cutting lines parallel to the cutting line 51 and obtain a size smaller filter structure. In the examples of FIGS. 8(B) and 8(C), a still smaller filter structure may be obtained by cutting the filter structure F6 on more inner cutting lines. The adoption of these aspects enables obtaining filter structures having various sizes after cutting.

### Seventh Embodiment

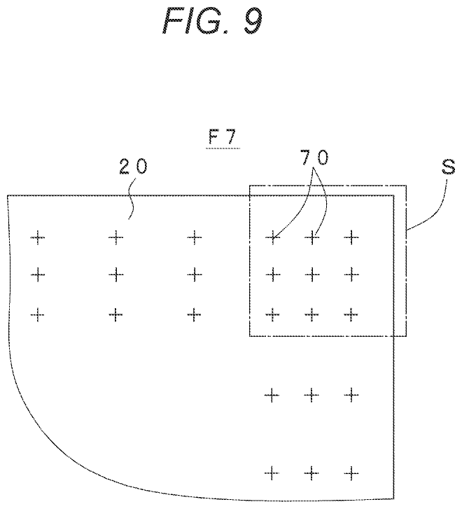

FIG. 9 is a rear view illustrating a part of a filter structure according to a seventh embodiment of the present invention.

The main features of the configuration of a filter structure F7 of the example are common to those of the third embodiment, and differences are mainly described here.

In the above-mentioned embodiments, the boundary portions are formed on the sheet layer 20 by, for example, printing, perforations, or half cutting. However, instead of this, the filter structure F7 of the example presents the boundary portions 40 of the to-be-cut regions S with marks 70 placed at regular intervals on the sheet layer 20. The marks 70 may be formed by printing, but may be formed by embossing or ruled line processing on the surface of the sheet layer 20 other than printing. The form of the marks 70 is not particularly limited, and examples of the form of the marks 70 are a cross shape, a circle, a square, a triangle, or a star shape.

The placement of the marks 70 at regular intervals on the sheet layer 20 enables cutting the filter structure F7 at a predetermined position with reference to the marks 70.

Note that in the above second embodiment, two types of outlines having different sizes are indicated on the filter layer. However, three or more types of outlines having different sizes may be indicated.

Moreover, the outlines and boundary portions that are formed on the filter layer in the above second embodiment may be formed not on the filter layer but on the sheet layer.

Conversely, the outlines and boundary portions that are formed on the sheet layer in the above fourth embodiment, the area indications formed on the sheet layer in the fifth embodiment, the cutting lines formed on the sheet layer in the sixth embodiment, and the marks formed on the sheet layer in the seventh embodiment may be formed not on the sheet layer but on the filter layer.

Furthermore, the boundary portions illustrated in these embodiments may be provided on both of the filter layer and the sheet layer. In this case, the filter layer and the sheet layer may have common indications, and different formation methods may be adopted.

Moreover, in each of the above embodiments, for example, the boundary portions are formed on either the filter layer or the sheet layer, but may be formed on both of the filter layer and the sheet layer.

Moreover, in each of the above embodiments, each of the to-be-cut regions is set in a rectangular shape, but may be set in another form.

Moreover, in each of the above embodiments, the each of the to-be-cut regions is set in a corner portion. However, the present invention is not limited to this. For example, when there is a portion that interferes with the filter layer on the inner side of a mounting target, or when there is a portion that is not appropriate to be covered with the filter layer since a sensor or the like is provided, the to-be-cut region may be set inward on the filter layer in accordance with these portions. In this case, the boundary portion may be formed as a cutting assist portion such as perforations to facilitate cutting off the to-be-cut region.

Moreover, in each of the above embodiments, the filter structure has a rectangular shape or a square shape. However, various shapes such as a polygon, a circle, and an ellipse may be adopted. In this case, for example, a circular filter structure has no corner portion. Therefore, it is simply required to set the to-be-cut region in a place corresponding to the portion that interferes with the mounting target, and form a boundary portion that indicates the limits of the to-be-cut region.

Moreover, in each of the above embodiments, the shape of the filter layer after cutting is set in such a manner as to be similar to that of the original filter layer. However, the shape after cutting may not be similar.

Moreover, in each of the above first to fifth embodiments, it is configured in such a manner that all the four to-be-cut regions can be cut off. However, an aspect in which only one to-be-cut region is set is also feasible.

Moreover, in the filter structure of each of the above embodiments, the entire filter layer may be used without cutting off the to-be-cut regions.

Moreover, the sheet layer in each of the above embodiments may include two divided sheet layers divided at a middle position of the filter layer in a case of a large-sized product such as a filter structure for a commercial AC. With this configuration, when the filter structure is mounted, the mounting operation can be facilitated through a procedure in which one of the two divided sheet layers is peeled off to expose half of the entire adhesive layer, the exposed adhesive layer is attached to the intake of the AC, and then the other divided sheet layer is peeled off to attach the remaining half to the remaining part of the intake. The sheet layer on the back side may be divided into three or more, may be divided unequally, or may be divided into different shapes.

Moreover, the adhesive layer in each of the above embodiments may include a design adhesive layer of, for example, a character, a symbol, a figure, or a pictorial pattern. The provision of the design adhesive layer enables contributing to attachment of the filter structure to a target object and adding a replacement indication function of indicating a replacement time of the filter structure. Moreover, a film that does not have air permeability or is inferior in air permeability to the filter layer may be thermally adhered and attached in advance to the filter layer to add the replacement indicator function.

Moreover, the filter structure of the present invention can be used not only for air purifiers and domestic and commercial ACs, but also for, for example, domestic and commercial equipment such as range hoods and ventilation fans for home and restaurant kitchens, and vents installed indoors and outdoors.

### INDUSTRIAL APPLICABILITY

The present invention can be applied to filter structure products used for, for example, air purifiers, domestic and commercial ACs, domestic and commercial equipment such as range hoods and ventilation fans for home and restaurant kitchens, and vents installed indoors and outdoors. In particular, it is possible to provide a filter structure product that can be used for both of an air purifier of the back-to-front airflow system and an air purifier of the front-to-back airflow system by cutting off, or cutting, a part of the filter structure product according to the mounting target. Moreover, it is possible to provide a filter structure product, one type of which can be adapted to mounting targets having intakes of different sizes, as in ceiling-embedded commercial ACs. Moreover, the present invention can provide filter structure products having various shapes such as a polygon, a circle, and an ellipse in addition to a rectangle and a square. Furthermore, it is possible to provide a filter structure product having the function of indicating a filter replacement time.

1. A filter structure (F1) comprising:
a filter layer (1) that has air permeability to filter passing gas;
an adhesive layer (10) formed of an adhesive on at least a part of one side of the filter layer; and
a peelable sheet layer (20) laminated on a surface of the adhesive layer, wherein
a to-be-cut region (3) is set on the filter layer, and
a boundary portion (4) indicating a boundary position between the to-be-cut region and a non-cut region (5) of the filter layer is formed on at least one of the sheet layer and the filter layer.

2. The filter structure according to claim 1, wherein
the boundary portion includes at least one selected from:
a visual indication, such as a line, a graphic, a character, a symbol, or a certain colored area, formed by printing;
a mark formed by embossing or ruled line processing; and
a cutting assist portion such as perforations or a half cut.

3. The filter structure according to claim 1, wherein
the filter layer has a rectangular form, and
the to-be-cut region is set in at least one corner portion of the filter layer.

4. The filter structure according to claim 2, wherein
the filter layer has a rectangular form, and
the to-be-cut region is set in at least one corner portion of the filter layer.
